(19) United States
(12) Patent Application Publication
(10) Pub. No.: US 2007/0074265 A1
(43) Pub. Date: Mar. 29, 2007

(54) Video processor operable to produce motion picture expert group (MPEG) standard compliant video stream(s) from video data and metadata

(76) Inventors: James D. Bennett, San Clemente, CA (US); Jeyhan Karaoguz, Irvine, CA (US)

Correspondence Address: GARLICK HARRISON & MARKISON, P.O. BOX 160727, AUSTIN, TX, 78716-0727, US

(21) Appl. No.: 11/255,697

(22) Filed: Oct. 21, 2005

Related U.S. Application Data
(60) Provisional application No. 60/720,577, filed on Sep. 26, 2005.

(51) Int. Cl. H04N 5/445; H04N 7/16; H04N 7/00

(52) U.S. Cl. 725/135; 725/136; 348/564; 348/563; 348/473

(57) ABSTRACT

Embodiments of the present invention are operable to produce MPEG or like video streams from video data that is accompanied by metadata. This greatly reduces the processing requirements associated with encoding an MPEG or other like standard video stream. This is achieved by decoding formatted video data received from a computer system with a video processor. A frame or series of frames may be produced from the formatted video data by the video processor. In the instance where a series of frames are produced, these may be supplied to a display driver and presented on an operatively coupled display. The image frame or series of image frames may be supplied to a video stream encoder along with the metadata wherein the video stream encoder is operable to apply the metadata to the image or series of images in order to produce a set of instructions that allow subsequent images to be generated from the image or images produced by the video processor. This second video stream can then be distributed within a video display network.

### CROSS REFERENCES TO RELATED APPLICATIONS

This Application is claims priority under 35 USC § 119(e) to Provisional Application No. 60/720,577 entitled “VIDEO PROCESSOR OPERABLE TO PRODUCE MOTION PICTURE EXPERT GROUP (MPEG) STANDARD COMPLIANT VIDEO STREAM(S) FROM VIDEO DATA AND METADATA,” which is incorporated herein by reference in its entirety for all purposes. This Application is related to application Ser. No. 10/856,124, filed May 28, 2004 which claims priority under 35 USC § 119(e) to Provisional Application No. 60/473,675, filed on May 28, 2003, both of which are incorporated herein by reference in their entirety. This Application is also related to application Ser. No. 10/856,430, filed May 28, 2004 which claims priority under 35 USC § 119(e) to Provisional Application No. 60/473,967 filed on May 28, 2003, both of which are incorporated herein by reference in their entirety.

### BACKGROUND OF THE INVENTION

1. Field of the Invention

This invention generally relates to video processing and more particularly to a video processor operable to produce Motion Picture Expert Group (MPEG) standard compliant video streams from video data and metadata.

2. Background of the Invention

As analog video collections are digitized and new video is created in purely digital forms, users have an unprecedented access to video material. Properly accessing and distributing this material presents problems. Such access assumes that video can be adequately stored and distributed with appropriate management and effective information retrieval techniques. The video, once digitally encoded, can be copied without further reduction in quality and distributed over the ever-growing communication channel(s) setup to facilitate the transfer of data. In one scheme, digitized image streams are analyzed and compressed such that the images are then described as a set of objects by graphical languages to which metadata is applied. Alternatively, image frames and a set of instructions applied to the image can be used to produce subsequent images such as in the case of the Motion Picture Expert Group (MPEG) standard.

Metadata, information about data including video data, can be assigned to one of three categories. These categories include descriptive, administrative, and structural. Descriptive provides additional information for identification and exploration. Administrative supports resource management within a collection such as for indexing and accessing purposes. Structural provides information to bind together the components of more complex information objects. For example, in a graphical language, structural metadata may be used to determine how the objects from which a graphical image is to be rendered relate and interact. Alternatively, structural metadata can take the form of a set of instructions that when applied to one image, produce another image. Without metadata, a 1,000-hour video archive comprises a terabyte or more of bits. With metadata, digital videos can become a valuable, searchable, and compact information resource.

Purely digital video has increasing amounts of descriptive information automatically created during the production process. This includes digital cameras that record the time and place of each captured shot, and tagging video streams with terms and conditions of use. Such descriptive metadata could be augmented with higher order descriptors (details about actions, topics or events). These descriptors could be produced automatically through analysis of the visual content in the video data stream. Another purely digital type of video may be computer-generated (CG) graphics using graphical languages. Computer generated images (CGI) are increasingly used within the entertainment industry for both passive and interactive video presentations. Likewise, video that was originally produced with little metadata can be analyzed to create additional metadata to better support subsequent retrieval from video archives.

Automatic analysis of analog or digital video in support of compression or of content-based retrieval has both become a necessary step in managing the archives. Archives having video created using graphical languages or other similar techniques to generate computer generated video are often generated on a frame by frame basis according to a traditional standard and then converted to a network-friendly standard such as the MPEG standard by computing the difference between each individual frame. This difference is converted to a set of instructions (structural metadata) which when applied to an initial frame image produced subsequent frame image(s).

Numerous strategies exist to reduce the number of bits required for digital video, from relaxed resolution requirements to compression techniques in which some information is sacrificed in order to significantly reduce the number of bits used in to encode the video. MPEG and its variants provide such compression standards. The MPEG process works by eliminating redundant and non-essential image information from the stored data. Less total bits means that the video information can be transferred more rapidly with reduced network bandwidth requirements.

One downfall of existing encoding schemes is two resource-intensive processes (i.e., the generation of each individual frame and then the computation of the differences between each individual frame) that each require large amounts of processing power and memory. Additionally, the process of generating subsequent frames from the initial frame and computed differences may result in a reduced image quality when compared to the original subsequent frames generated using graphical languages. Therefore, a need exists for of the ability to more efficiently generate network-friendly video streams, such as those compliant with the MPEG standard that can be distributed more efficiently and effectively within a network (wired or wireless) environment.

### BRIEF SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE SEVERAL VIEWS OF THE DRAWINGS

FIG. 1 provides an architectural overview of a computing system including functional blocks and their relationships;

FIG. 2 illustrates an existing video processor operable to produce an MPEG video stream from video data;

FIG. 3 depicts a video processing system operable to interface with a computer system in order to produce and distribute MPEG standard compliant video streams in accordance with an embodiment of the present invention;

FIG. 4 depicts a video processing system that interfaces with a computer system to produce and distribute MPEG standard compliant video streams in accordance with an embodiment of the present invention;

FIG. 5 depicts a video processing system that takes the form of a card operable to interface with a computer system bus and produce and distribute MPEG standard compliant video streams in accordance with an embodiment with the present invention;

FIG. 6 provides a logic flow diagram of a method of producing and distributing an MPEG compliant video stream in accordance with an embodiment of the present invention; and

FIG. 7 provides a second logic flow diagram of a method with which to produce and distribute MPEG compliant video streams in accordance with an embodiment of the present invention.

### DETAILED DESCRIPTION OF THE INVENTION

Preferred embodiments of the present invention are illustrated in the FIGUREs, like numerals being used to refer to like and corresponding parts of the various drawings.

Certain terms are used throughout the description and claims to refer to particular system components. As one skilled in the art will appreciate, computer components may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical, mechanical, or optical connection. Thus, if a first device couples to a second device, that connection may be through a direct electrical, mechanical, or optical connection, or through an indirect electrical, mechanical, or optical connection via other devices and connections. The term “computer” is used in this specification broadly and includes a personal computer, workstation, file server, or other microprocessor-based device, which can be programmed by a user to perform one or more functions and/or operations.

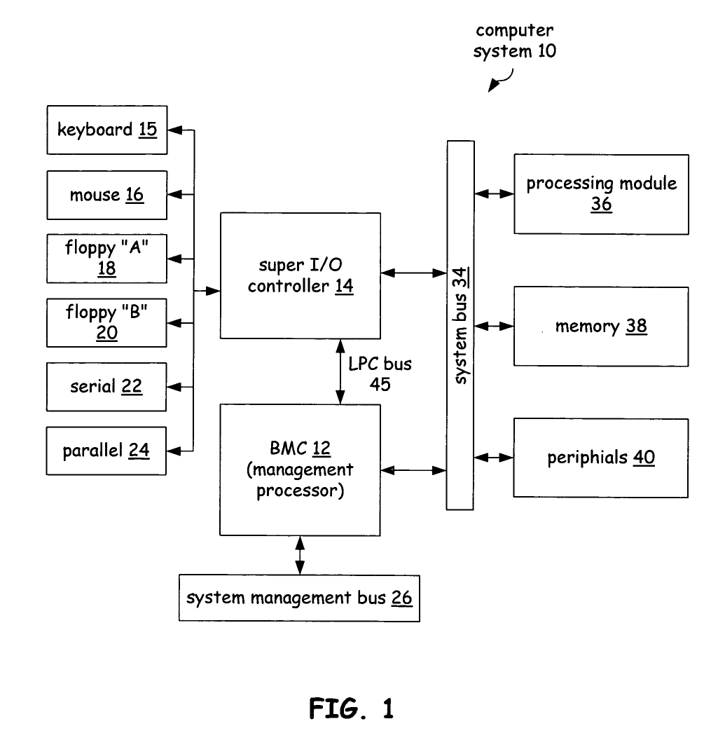

FIG. 1 provides an architectural overview of computing system 10 including functional blocks and their electrical relationships. Computer system 10 may perform the role of a file server operable to distribute video within a network environment or supply video to an attached display. The computer system includes BMC 12 serving as the management processor; super IO controller 14, wherein super IO controller 14 further contains keyboard interface 15, mouse interface 16, FDD “A” interface 18, FDD “B” interface 20, serial port interface 22 and parallel port interface 24; system bus 34; system management bus 26, which includes a processing module 36; memory 38; and peripherals 40.

Processing module 36 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 38 may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module 36 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Various peripheral devices 40 may include for example, video and media processors or processing cards, network interface cards, DVD-ROM drives, data drives using compression formats such as the ZIP format, and Personal Computer Memory Card International Association (PCMCIA) slots/drives. Various other peripheral devices are available in the industry, including keyboards, monitors, mice, printer, and speakers, among others. In addition, as one skilled in the art will understand, various composite peripheral devices may connect, including devices that combine the features of conventional items, such as printers/scanners/fax machines, and the like.

FIG. 1 generally illustrates the architecture of computer system 10. One should realize that many different architectures are possible without affecting the departing from the spirit of the present invention. For example, some architectures divide system bus 34 into two busses, the Northbridge and Southbridge. The Northbridge generally couples to memory and processing modules, while the Southbridge generally couples to peripherals. Various system bus compliant devices may connect to system bus 34. Through system bus 34, processing module 36 can communicate with various system devices, including, but not limited, to peripheral devices 40 connected to system bus 34. In accordance with the protocol of system bus 34, such as the peripheral component interconnect (PCI) bus protocol, various devices may read data from and write data to memory 38.

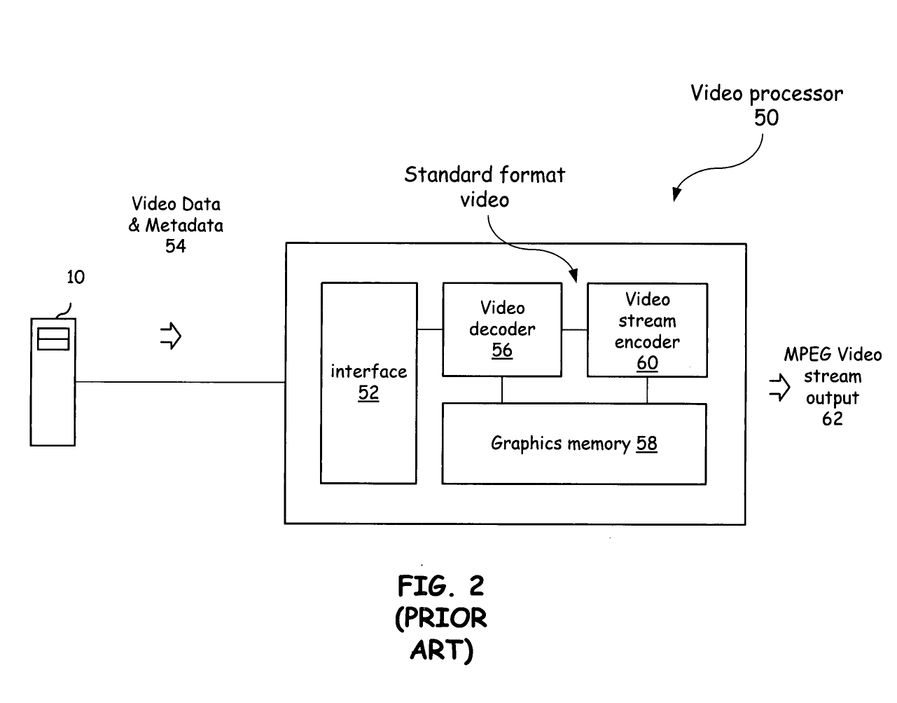

FIG. 2 functionally illustrates the processes within an existing video processor 50 operable to produce a motion picture expert group (MPEG) video stream from video data supplied. Interface 52 receives video data 54 from computer system 10. This video data is then supplied to video decoder 56. Video decoder 56 and associated memory 58 produces a video signal in a standard format such as SVGA, VGA, HDTV or other like video formats known to those having skill in the art. Video stream encoder 60 couples to memory 58 and video decoder 56 to produce MPEG compliant video stream output 62. As shown, video stream encoder 60 produces from the standard format video a network-friendly video stream using a standard such as the MPEG standard by computing the difference between each individual frame. This difference is converted to a set of instructions (structural metadata) which when applied to an initial frame image produced subsequent frame image(s).

The MPEG standard includes variants such as MPEG 4 and MPEG 7 which specify a standard way of describing various types of multimedia information, including still pictures, video, speech, audio, graphics, 3D models, and synthetic audio and video. The MPEG 4 standard was conceived with the objective of obtaining significantly better compression ratios than could be achieved by conventional coding techniques.

Decoding and encoding in this manner is very processing intensive. Additionally, when processors are assigned multiple processing duties, increased encoding and decoding associated with video standards such as MPEG 4 require additional processing power in order to stream real-time multimedia. These processing requirements require new methods with which to balance the processing requirements of the system processor. Video encoder 60 may service MPEG-1/2/4, 7 and 21, H.261/H.263, other like video compression standards, or any other like video encoding/decoding operations. MPEG 4 is particularly suited to wireless environments and allows a reasonable reproduction of the video frame with a relatively low data rate. Additionally, processing in this manner may result in decreased quality as the MPEG video stream is encoded from decoded video as opposed to the instructions used to create the standard format video.

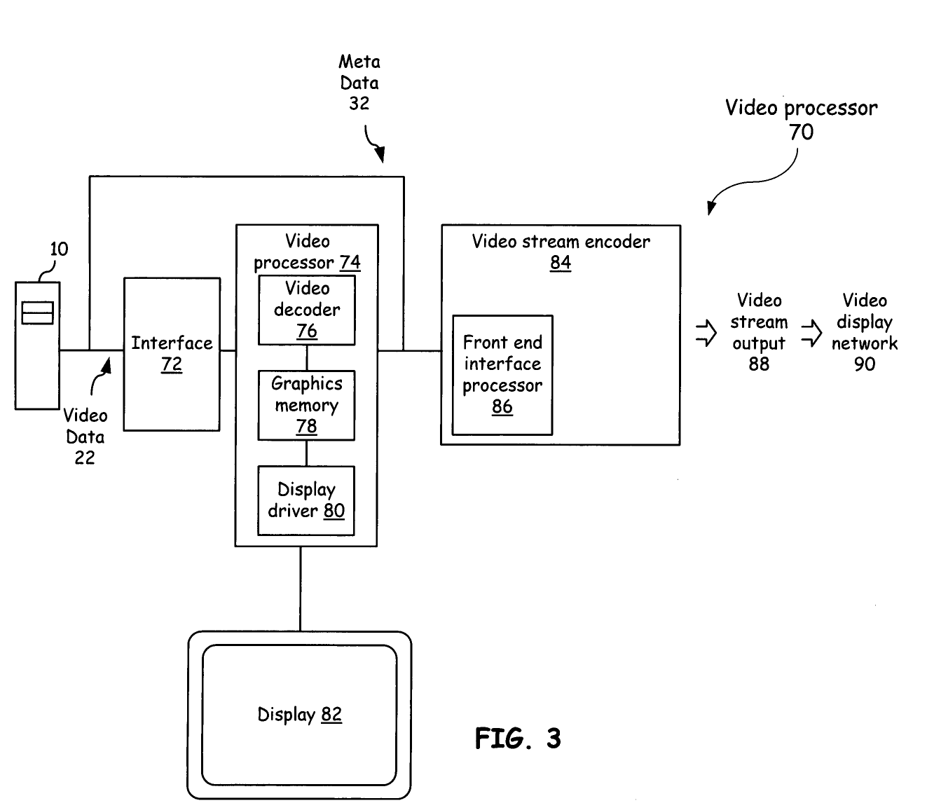

FIG. 3 depicts a video processing system 70 that interfaces with computer system 10 operable to produce and distribute MPEG or like standard video streams. Interface 72 between computer system 10 and video processing component 60 are generally known and support a standard video format(s) known to those having skill in the art. This standard video format will include application program interface (API) commands that are generally known. These commands include open graphical languages (GL) commands, direct access commands and other commands that may be consistent with a Super Video Graphics Adapter (SVGA) format, UGVA format, high definition (HD) format, or another format that is known to those having skill in the art. Video processor component 74 includes video decoder 76 and memory 78 and couples to interface 72. Video decoder 76 performs the first video decoding operations consistent with those generally known to drive a computer display 82 with a display driver 80 such as a row/scanning interface. Video decoder 76 operates in conjunction with memory 78 to produce frame images by processing video data 22 received from shared computer system 10. A resultant of the operations of video decoder 76 are images within memory 78 that may be used by display driver 80 to produce an output to drive display 82. Such output is displayed in a conventional manner on the display.

Also included is video stream encoder 84 that interfaces both with video processor 74 and computer system 10. Video stream encoder 84 receives information, the standard format video or access to the images within memory 78, from video processor 74 and metadata computer system 10. The video stream encoder uses the information received from video processor 74 and metadata received from computer system 10 to more efficiently produce an MPEG encoded video stream output. Video stream encoder 84 includes a front-end processor 86 that interfaces with video processor 74 as well as computer system 10. In such case, video stream encoder 84 receives metadata 32 from computer system 10 and standard format video from video processor 74. Such other formats may include but are not limited to: High definition Television (HDTV), OpenGL, a 3D graphics language variant, DirectX, Moving Picture Experts Group (MPEG), Video Graphics Adapter (VGA), Super VGA (SVGA), and Enhanced Graphics adapter (EGA).

The output of video stream encoder 84 is a video stream, such as an MPEG video stream, that may be distributed to one or more display devices within a consolidated video display network 90. Video stream encoder 84 uses both metadata 32 received from computer system 10 and the output from video processor 74 to produce video stream 88. In this way, video stream encoder 84 does not use conventional encoding operations that simply compare a series of input images. Rather, video encoder 84 uses metadata 32 to more efficiently and accurately produce the output video stream from frames within the standard format video.

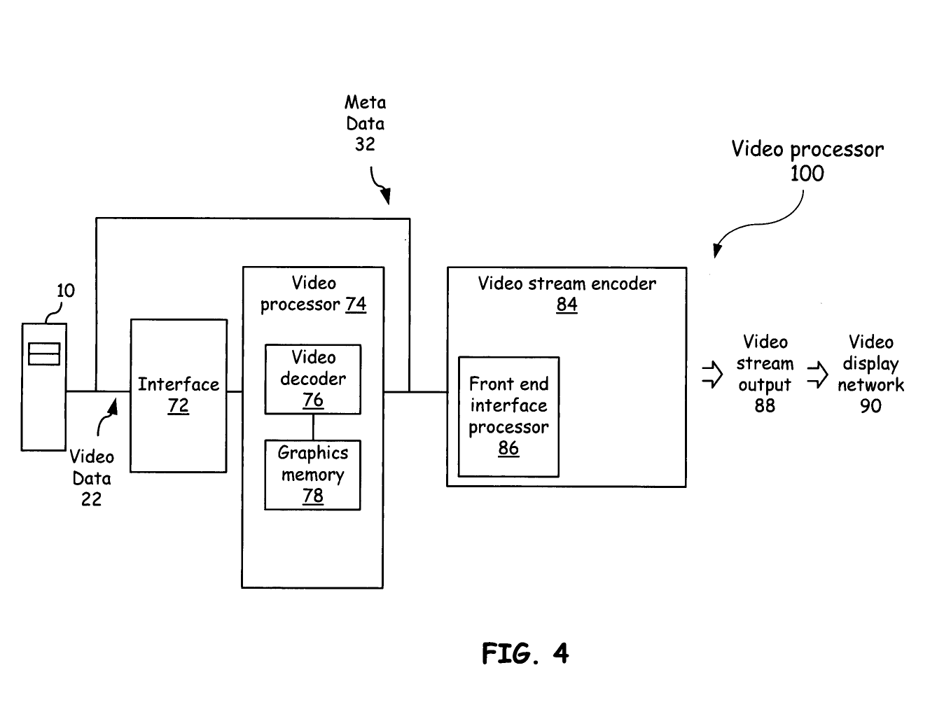

FIG. 4 presents a video processing system 100 that is similar to that presented in FIG. 3. However, video processing system 100 lacks the ability to directly drive display 82 with display drivers 80. Thus, FIG. 4 is operable to more efficiently generate an MPEG or other like video stream for distribution that uses both metadata and video data.

FIGS. 3 and 4 provide alternatives to the brute force processing depicted in FIG. 2. Video processing systems 70 and 100 couples to computer system 10 in order to receive video data 22 and metadata 32 from computer system 10. Interfaces may couple to system bus 34 of computer system 10 in FIG. 1. This video data is provided to video processor 64.

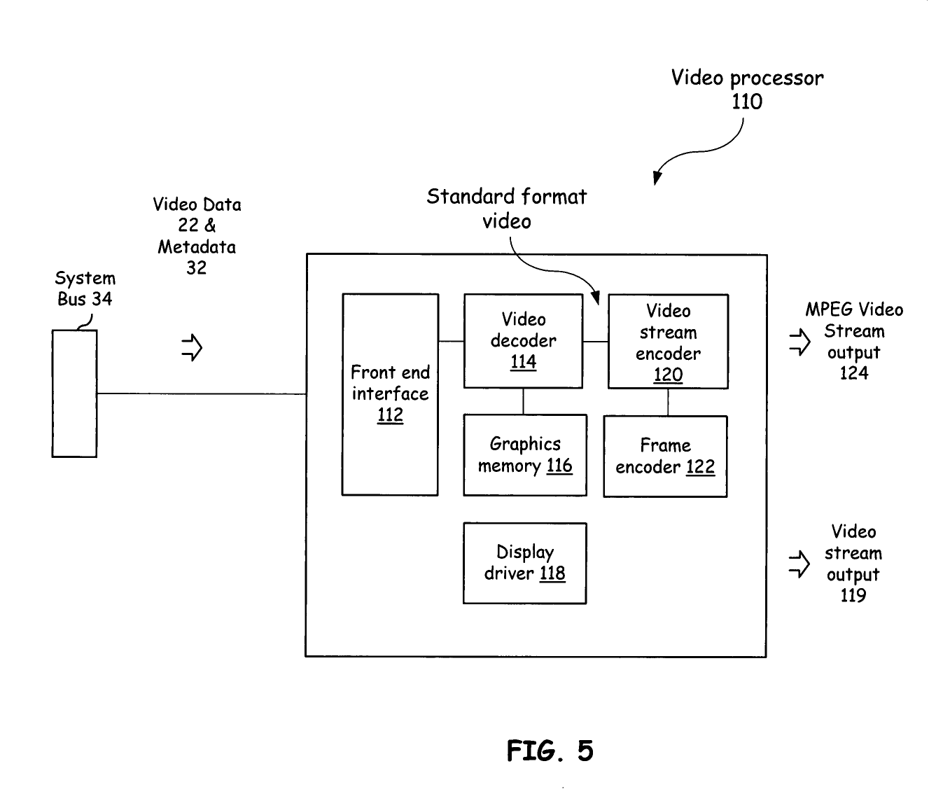

FIG. 5 depicts an embodiment of the video processing systems provided by the present invention as a video processing card 110 operable to communicatively couple to system bus 34 of computer system 10. As described previously, video data 22 and metadata 32 are received by interface 112 within the video processing card 110. A video decoder 114 operating with graphics memory 116 produces a stream of frames 119 which may be supplied to a display driver 118 and output as a standard format video stream output. Alternatively, this video stream output 119 may be supplied to video stream encoder 120 that may use selected frames within the video stream in conjunction with metadata 32 associated with video data 22 in order to more accurately generate sets of instructions on how to produce subsequent frames from earlier frames. This greatly reduces the processing requirements on the video stream encoder 120 as differences in motion compensation are not determined between frames but rather are determined from the original instructions of how objects within the frames interact. This will result in a higher quality MPEG video stream output 124 from video stream encoder 120.

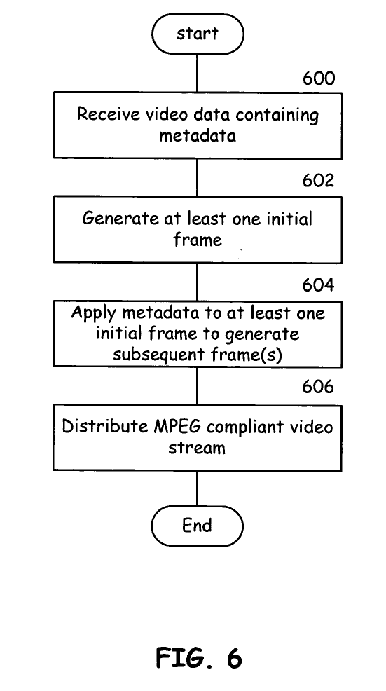

FIG. 6 provides a logic flow diagram of a method of producing a video stream. In step 600, video data containing metadata is received. As previously described, this may be received by a video processor operably coupled to a computer system in one embodiment. In step 602, an initial frame is generated from the video data. The subsequent frames are not necessarily generated but rather metadata describing the interaction of objects within the initial frame is applied to the initial frame to generate instructions on how to generate subsequent frames from the initial frame in step 604. In this manner, an MPEG compliant video stream can be produced while avoiding the processing associated with a direct comparison of adjacent frames. This MPEG compliant video stream may then be distributed in step 606. Concurrent to step 602, should the video processor be required to generate both an MPEG compliant video stream and other standard format video streams, to the video processor may generate a standard format video and output that video stream. The encoder is not required to compare the adjacent frames of this video stream to generate the MPEG compliant video stream in this embodiment.

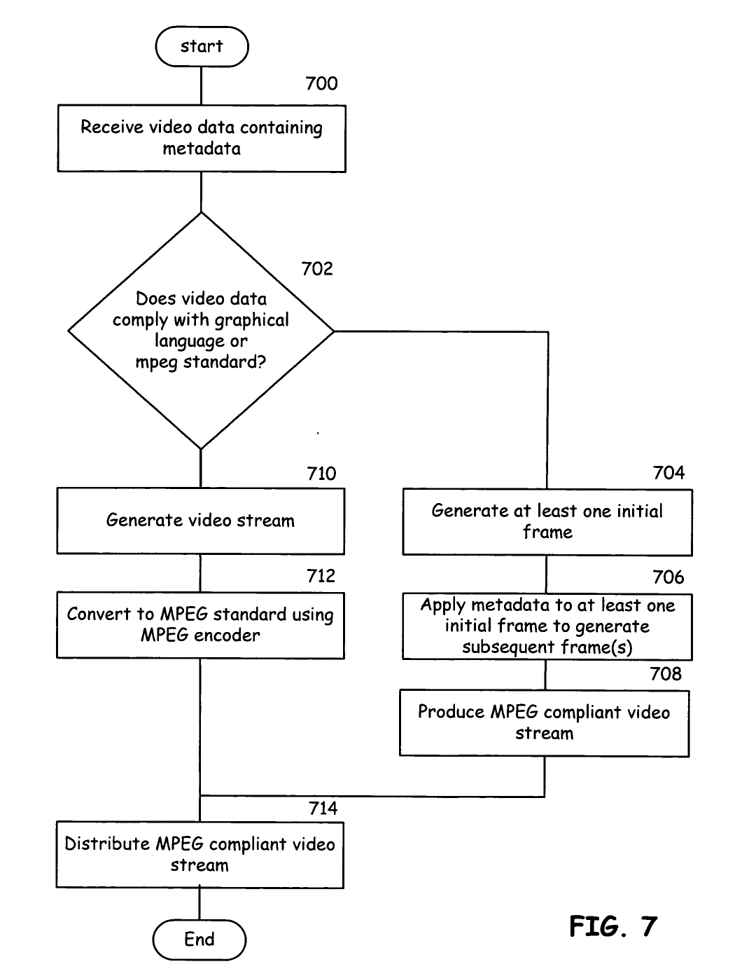

FIG. 7 provides another logic flow diagram of a method to produce an MPEG compliant video stream. Step 700 receives formatted video data containing metadata. Decision point 702 determines whether or not the video data complies with a graphical language or MPEG standard. Such compliance would require metadata that accompanies the video data to provide instructions of how graphical objects interact in the case of a graphical language or the differences between frames when the video data complies with a standard such as the MPEG standard. If this data is not contained, the processed video stream is generated in step 710 and then uses a conventional MPEG encoder to convert the video stream directly to an MPEG compliant video stream in step 712. This stream may then be distributed in step 714.

When the video data does comply with the graphical language or MPEG standard at decision point 702, it is possible to generate initial frames in step 704. Metadata may then be applied to the initial frame to generate instructions on how to generate subsequent frames in step 706. In this manner, an MPEG compliant video stream is produced in step 708 by a process that is less process intensive when compared to the processes of step 712. In either case, the MPEG compliant video stream may be distributed in step 714.

In summary, embodiments of the present invention may produce MPEG or like video streams from video data that is accompanied by metadata. This greatly reduces the processing requirements associated with encoding an MPEG or other like standard video stream. This is achieved by decoding formatted video data received from a computer system with a video processor. A frame or series of frames may be produced from the formatted video data by the video processor. In the instance where a series of frames are produced, these may be supplied to a display driver and presented on an operatively coupled display. The image frame or series of image frames may be supplied to a video stream encoder along with the metadata wherein the video stream encoder is operable to apply the metadata to the image or series of images in order to produce a set of instructions that allow subsequent images to be generated from the image or images produced by the video processor. This eliminates the need for computationally intensive processes such as the comparison of adjacent frames. This second video stream can then be distributed within a video display network.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As one of average skill in the art will appreciate, other embodiments may be derived from the teaching of the present invention without deviating from the scope of the claims.

What is claimed is:

1. A method operable to produce at least two video streams, comprising:
receiving formatted video data from a computer system, wherein the formatted video data is accompanied by metadata;
decoding the formatted video data with a video processor;
producing with the video processor a first video stream that comprises a series of image frames, wherein the series of image frames are operable to be presented on a display;
supplying the first video stream and metadata, wherein the metadata is synchronized to the first video stream, to a video stream encoder;
producing, with the video stream encoder, a second video stream based on the first video stream and metadata; and
distributing the second video stream within a video display network.

2. The method of claim 1, wherein the formatted video data comprises video data utilizing a first video standard selected from the group consisting of:
High definition Television (HDTV);
OpenGL;
a 3D graphics language variant;
DirectX;
Moving Picture Experts Group (MPEG);
Video Graphics Adapter (VGA);
Super VGA (SVGA); and
Enhanced Graphics adapter (EGA).

3. The method of claim 1, wherein the second video stream utilizes a variant of a Moving Picture Experts Group (MPEG) standard.

4. The method of claim 1, wherein producing, with the video stream encoder, the second video stream based on the first video stream and metadata further comprises:
applying the metadata to a frame within the series of image frames to produce at least one subsequent frame.

5. The method of claim 1, wherein the second video stream is distributed wirelessly to the display network.

6. The method of claim 1, wherein the metadata comprises object information for objects within the formatted video data.

7. A method operable to produce a Moving Picture Experts Group (MPEG) video stream, comprising:
receiving formatted video data from a computer system, wherein the formatted video data is accompanied by metadata;
decoding the formatted video data with a video processor;
producing with the video processor at least one image frame from the formatted video data; and
applying the metadata to the at least one frame to produce the MPEG video stream.

8. The method of claim 7, wherein the formatted video data comprises video data utilizing a first video standard selected from the group consisting of:
Direct3D;
OpenGL;
a 3D graphics language variant;
DirectX;
Moving Picture Experts Group (MPEG);
Video Graphics Adapter (VGA);
Super VGA (SVGA); and
Enhanced Graphics adapter (EGA).

9. The method of claim 7, wherein the MPEG video stream utilizes a variant of the MPEG standard.

10. The method of claim 9, wherein the MPEG video stream is distributed wirelessly to a display network.

11. The method of claim 7, wherein the metadata comprises object information for objects within the formatted video data.

12. A video processing system operable to distribute a Moving Picture Experts Group (MPEG) video stream, comprising:
an interface operable to receive formatted video data from a computer system, wherein the formatted video data is accompanied by metadata;
a video decoder operably coupled to the interface and memory, wherein the video decoder is operable to produce a plurality of image frames from the formatted video data; and
a video stream encoder, operably coupled to the computer system and the video decoder, wherein the video stream encoder is operable to produce the MPEG video stream from the plurality of image frames and the metadata.

13. The video processing system of claim 12, wherein the video decoder is further operable to produce a second video stream comprising a stream of the plurality of image frames.

14. The video processing system of claim 12, further comprising a display driver operable to render the second video stream to a monitor.

15. The video processing system of claim 14, wherein the display driver renders the second video stream by scanning rows and columns.

16. The video processing system of claim 12, wherein a video display network operably couples to the output of the video stream encoder.

17. The video processing system of claim 12, wherein a video display network operably wirelessly couples to the output of the video stream encoder.

18. A video card operable to render a Moving Picture Experts Group (MPEG) video stream, comprising:
an interface operable to receive formatted video data from a computer system, wherein the formatted video data comprises metadata;
a video processor comprising:
a video decoder operably coupled to the interface, wherein the video decoder is operable to produce a plurality of image frames from the formatted video data; and
computer memory operably coupled to the video decoder, wherein the computer memory is operable to store the plurality of image frames; and
a video stream encoder, operably coupled to the computer system and the video processor, wherein the video stream encoder is operable to produce the MPEG video stream from the plurality of image frames and the metadata.

19. The video card of claim 18, wherein the plurality of image frames comprises a second video stream.

20. The video card of claim 18, further comprising a display driver operable to render the second video stream to a monitor.

21. The video card of claim 20, wherein the display driver renders the second video stream by scanning rows and columns.

22. The video card of claim 18, further comprising a display network interface operably coupled to the MPEG encoder, wherein the display network interface delivers the MPEG stream to a display network.

23. The video card of claim 22, wherein the display network interface wirelessly delivers the MPEG stream to the display network.

24. The video card of claim 22, wherein the formatted video data comprises video data utilizing a first video standard selected from the group consisting of:
High definition Television (HDTV);
OpenGL;
a 3D graphics language variant;
DirectX;
Moving Picture Experts Group (MPEG);
Video Graphics Adapter (VGA);
Super VGA (SVGA); and
Enhanced Graphics adapter (EGA).
